(19) United States
(12) Patent Application Publication
(10) Pub. No.: US 2011/0119690 A1
(43) Pub. Date: May 19, 2011

(54) EJECTING MECHANISM

(75) Inventors: Chih-Chen Lo, Taipei City (TW); Chih-Chin Yu, Taipei City (TW)

(73) Assignee: INVENTEC CORPORATION, Taipei City (TW)

(21) Appl. No.: 12/652,233

(22) Filed: Jan. 5, 2010

(30) Foreign Application Priority Data
Nov. 19, 2009 (TW) 98139341

(51) Int. Cl. G11B 17/04

(52) U.S. Cl. 720/601; G9B/17.013

(57) ABSTRACT

An ejecting mechanism suitable for being disposed in a housing of an electronic device is provided. The ejecting mechanism includes a guiding plate, a pair of stopping elements, and a moving element. The guiding plate is disposed on the housing. The stopping elements are disposed on the guiding plate, and the stopping elements are adapted to move away from each other or close to each other in a first direction. The moving element is disposed at the housing and movable in a second direction. The moving element has two pushing portions disposed on a second surface of the moving element that faces the stopping elements.

### CROSS-REFERENCE TO RELATED APPLICATION

This application claims the priority benefit of Taiwan application serial no. 98139341, filed Nov. 19, 2009. The entirety of the above-mentioned patent application is hereby incorporated by reference herein and made a part of this specification.

### BACKGROUND OF THE INVENTION

1. Field of the Invention

The present invention relates to a mechanism, and more particularly, to an ejecting mechanism being adapted in an electronic device.

2. Description of Related Art

The main difference between a portable computer and a traditional desk-top computer lies in that the portable computer is light-weighted, thin, short and small which makes it easy to carry. In addition, the portable computer provides the possibility of operating under various environments. However, because of its design requirements of being light, thin, short and small, the function and expandability of the portable computer is much weaker than that of the desk-top computer which has a larger manipulation space.

Accordingly, an electronic device, such as a docking station, for connection with the portable computer has been developed, which permits a user to connect peripheral devices, such as the mouse, printer, external hard disk drive, or scanner to the docking station over a long period of time. When the user needs to use these peripheral devices, the user only needs to connect the portable computer to the docking station to electrically connect the portable computer to the peripheral devices. As such, this not only allows the user to benefit from the portability of the portable computer, but also eliminates the trouble of plugging the peripheral devices into or being disengaged from the portable computer by using the docking station. In addition, the docking station makes the function and expandability of the portable computer as strong as the desk-top computer.

The peripheral devices mounted in the docking station to provide the functional expansion needs to be removed from the docking station for repair or replacement when they are damaged. However, if the user accidentally touches or pulls an ejecting button or pull handle, the peripheral devices may possibly be ejected out of the docking station and suffer from falloff damage.

### SUMMARY OF THE INVENTION

The present invention provides an ejecting mechanism which can be utilized in an electronic device for preventing peripheral devices from being disengaged from the electronic device.

The present invention provides an ejecting mechanism for being mounted in a housing of an electronic device. The ejecting mechanism includes a guiding plate, a pair of stopping elements, and a moving element. The guiding plate is disposed on the housing. The stopping elements are disposed on the guiding plate. The stopping elements are adapted to move away from each other or close to each other in a first direction. The moving element is disposed at the housing. The moving element is movable in a second direction and includes two pushing portions disposed on a second surface of the moving element that faces the stopping elements.

According to one embodiment of the ejecting mechanism, the first direction and the second direction are substantially perpendicular to each other.

According to one embodiment of the ejecting mechanism, the moving element further comprises a first stopping portion disposed on a third surface opposite to the second surface, and the first stopping portion is a protrusion.

According to one embodiment of the ejecting mechanism, the guiding plate comprises two guiding posts, each of the stopping elements has a guiding slot, and the guiding posts are accommodated in the guiding slots, respectively.

According to one embodiment of the ejecting mechanism, each of the stopping elements has a guiding surface facing to each other. When the moving element moves toward the second direction, the pushing portions move along the guiding surfaces to drive the stopping elements move away from each other in the first direction.

According to one embodiment of the ejecting mechanism, the ejecting mechanism further includes a rotating element pivoted to the housing and disposed below the guiding plate. A first surface of the rotating element that away from the housing comprises a second stopping portion disposed thereon. When the rotating element is at a locked position, the second stopping portion is on a moving path of the first stopping portion to restrain the first stopping portion. The second stopping portion is a protrusion.

In view of the foregoing, the rotating element of the ejecting mechanism can stop the movement of the moving element, thereby preventing the moving element from accidentally driving the peripheral device being ejected out of the electronic device.

In order to make the aforementioned and other features and advantages of the present invention more comprehensible, embodiments accompanied with figures are described in detail below.

### BRIEF DESCRIPTION OF THE DRAWINGS

FIG. 1 is a top view of an electronic device employing an ejecting mechanism according to one embodiment of the present invention.

FIG. 2 is a perspective view of the ejecting mechanism of FIG. 1.

FIG. 3 is a top view of the second stopping portion of the ejecting mechanism of FIG. 1 that departs from the locked position.

FIG. 4 is a perspective view of the ejecting mechanism of FIG. 3.

FIG. 5 is a top view of the moving element of the ejecting mechanism that moves toward the second direction.

### DESCRIPTION OF THE EMBODIMENTS

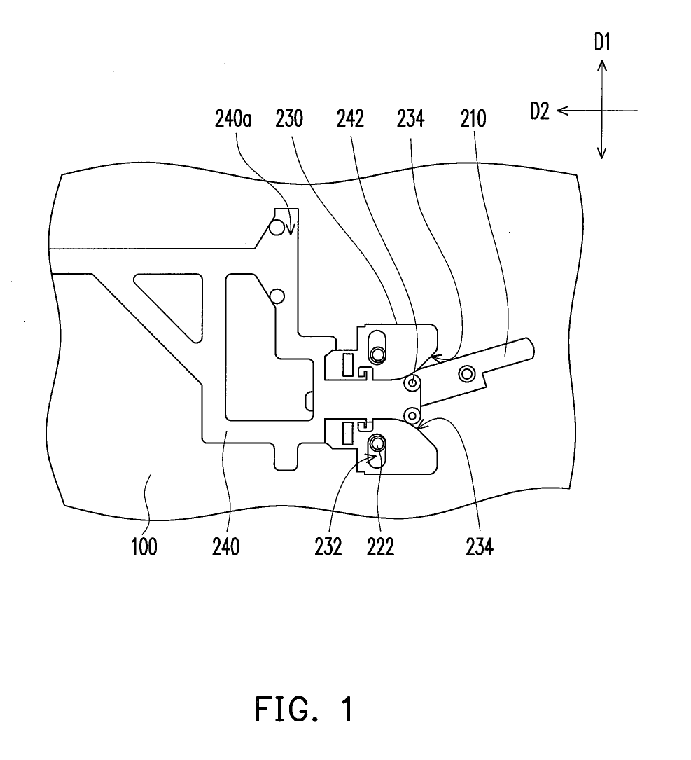

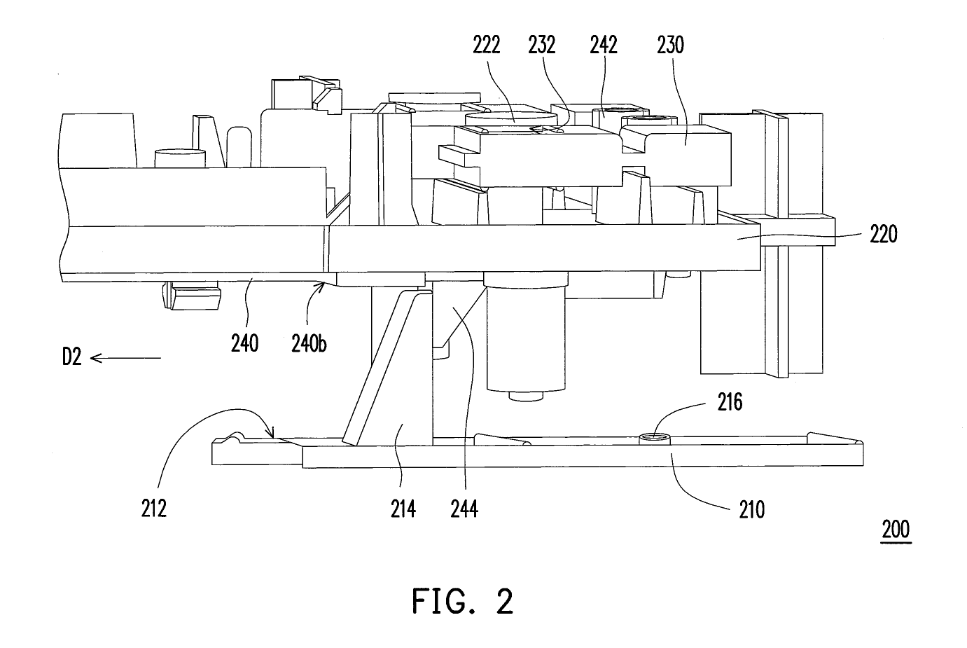

FIG. 1 is a top view of an electronic device that employs an ejecting mechanism according to one embodiment of the present invention. FIG. 2 is a perspective view of the ejecting mechanism of FIG. 1. Referring to FIG. 1 and FIG. 2, the ejecting mechanism 200 of the present embodiment is mounted in a housing 100 of an electronic device (unlabeled), for example, the electronic device is a docking station. The ejecting mechanism 200 of the present embodiment is used to drive a peripheral device (e.g. an optical disc drive) in the docking station to be ejected out of the docking station.

As shown in FIG. 1 and FIG. 2, the ejecting mechanism 200 includes a guiding plate 220, a pair of stopping elements 230, and a moving element 240. The guiding plate 220 is disposed on the housing 100. The stopping elements 230 are disposed on the guiding plate 220 and adapted to move away from each other or close to each other in a first direction D1. The moving element 240 is disposed at the housing 100 and movable in a second direction D2 that is substantially perpendicular to the first direction D1. In addition, the moving element 240 includes two pushing portions 242 formed on a second surface 240a of the moving element 240. It is noted that, for clarity, the guiding plate 220 is not shown in FIG. 1 and the housing 100 is not shown in FIG. 2.

The moving element 240 contacts the peripheral device in the docking station. When the moving element 240 moves toward the second direction D2, the peripheral device connected with the moving element 240 is driven and then ejected out of the docking station. In addition, the guiding plate 220 includes two guiding posts 222. Each stopping element 230 has a guiding slot 232. Each guiding post 222 is accommodated in a corresponding guiding slot 232 to restrain the moving direction and moving distance of the stopping element 230.

In addition, the moving element 240 further includes a first stopping portion 244 positioned on a third surface 240b opposite to the second surface 240a. The ejecting mechanism 200 further includes a rotating element 210 that is pivoted to the housing 100 and disposed between the guiding plate 220 and the housing 100. A first surface 212 of the rotating element 210 that faces away from the housing 100 includes a second stop portion 214 formed thereon. When the rotating element 210 is at a locked position, the second stopping portion 214 is located on a moving path of the first stopping portion 244 to restrain the first stopping portion 244, such that the peripheral devices such as optical disc drives are prevented from being ejected out of the docking station. The first stopping portion 244 and the second stopping portion 214 may be protrusions and the protrusions may be of a triangle in shape.

With continuous reference to FIG. 1 and FIG. 2, when the rotating element 210 is pushed by a moving element (not shown, which is not the same as the moving element 240 in the present embodiment) in the electronic device (unlabeled) so as to cause the second stopping element 214 to rotate to the locked position, the second stopping portion 214 is located on the moving path of the first stopping portion 244 to restrain the movement of the first stopping portion 244. In other words, at this time, the moving element 240 is retained by the rotating element 210 such that the moving element 240 is unable to move toward the second direction D2. As such, the peripheral device such as the optical disc drive in contact with the moving element 240 is held in position from being ejected out of the electronic device.

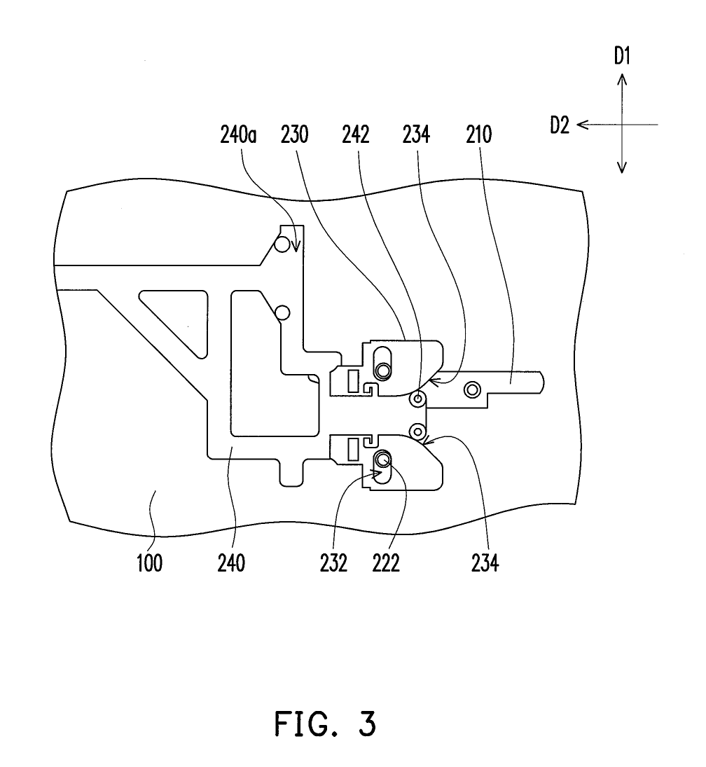

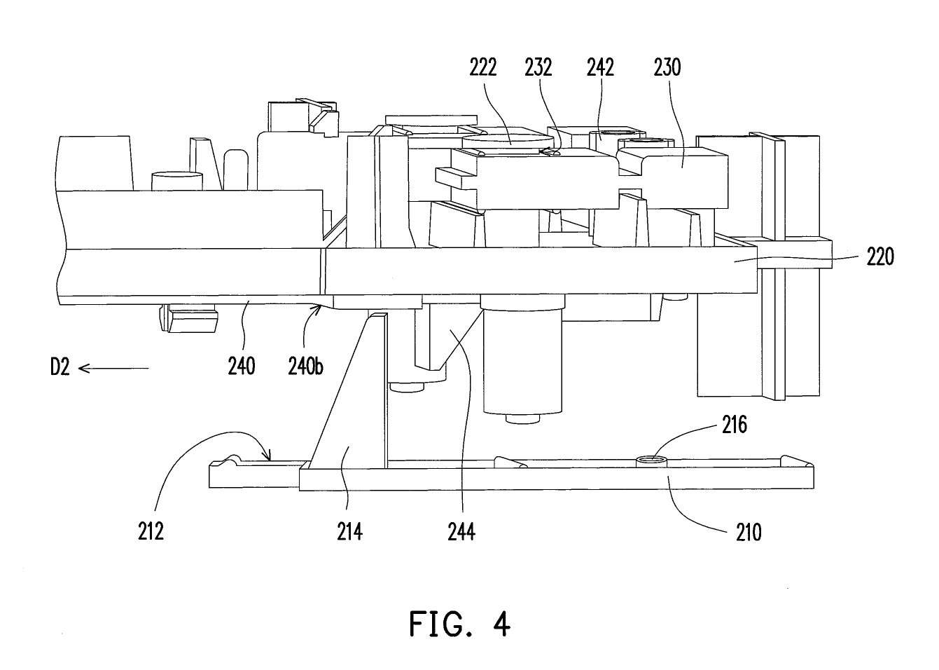

FIG. 3 is a top view of the second stopping portion of the ejecting mechanism of FIG. 1 that departs from the locked position. FIG. 4 is a perspective view of the ejecting mechanism of FIG. 3. For clarity, the guiding plate 220 is not shown in FIG. 3 and the housing 100 is not shown in FIG. 4. Referring to FIG. 3 and FIG. 4, to eject the peripheral device out of the electronic device, the rotating element 210 is rotated about its axle 216 to cause the second stopping element 214 to depart from the locked position. At this time, the second stopping portion 214 departs from the moving path of the first stopping portion 244. As such, no structure or element retains the first stopping portion 244 to restrain the movement of the moving element 240.

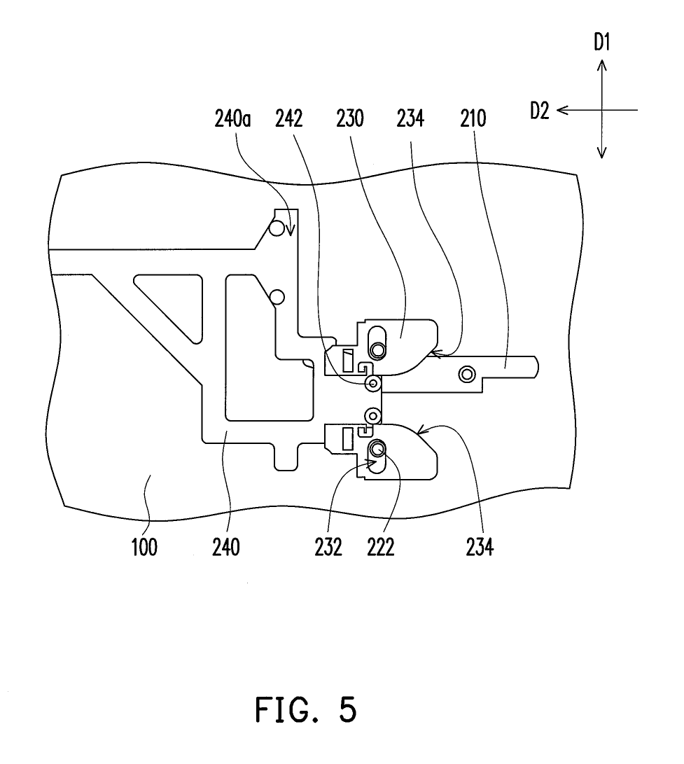

FIG. 5 is a top view of the moving element of the ejecting mechanism that moves toward the second direction. Referring to FIG. 5, afterwards, the user may operate a handle or button to drive the moving element 240 to move toward the second direction D2 to eject the peripheral device connected with the moving element 240 out of the electronic device. It is noted that each stopping element 230 has a guiding surface 234 facing to the guiding surface of another stopping element 230. When the moving element 240 moves toward the second direction D2, the pushing portions 242 moves along the guiding surfaces 234 to make the stopping elements 230 move away from each other in the first direction D1, while the moving direction and moving distance of the guiding posts 222 accommodated in corresponding guiding slots 232 are restrained due to the shape and size of the guiding slots 232, and therefore the moving direction and moving distance of the stopping elements 230 with respect to the guiding plate 220 are also restrained.

In summary, the moving element and stopping elements of the present ejecting mechanism are configured and operate in a manner different from that of the existing ejecting mechanism and therefore are patentable. In addition, because the rotating element is provided, the rotating element is rotated to drive the stopping portion to rotate to the locked position and the movement of the moving element connected with the peripheral device is surely retained, thereby preventing the peripheral device from being ejected out of the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An ejecting mechanism for being mounted in a housing of an electronic device, the ejecting mechanism comprising:
a guiding plate disposed on the housing;
a pair of stopping elements disposed on the guiding plate, the stopping elements being adapted to move away from each other or close to each other in a first direction; and
a moving element disposed at the housing, the moving element being movable in a second direction and comprising two pushing portions disposed on a second surface of the moving element that faces the stopping elements.

2. The ejecting mechanism according to claim 1, wherein the first direction and the second direction are substantially perpendicular to each other.

3. The ejecting mechanism according to claim 1, wherein the moving element further comprises a first stopping portion disposed on a third surface opposite to the second surface.

4. The ejecting mechanism according to claim 3, wherein the first stopping portion is a protrusion.

5. The ejecting mechanism according to claim 1, wherein the guiding plate comprises two guiding posts, each of the stopping elements has a guiding slot, and the guiding posts are accommodated in the guiding slots, respectively.

6. The ejecting mechanism according to claim 1, wherein each of the stopping elements has a guiding surface facing to each other, and when the moving element moves toward the second direction, the pushing portions move along the guiding surfaces to drive the stopping elements move away from each other in the first direction.

7. The ejecting mechanism according to claim 1, further comprising a rotating element pivoted to the housing and disposed below the guiding plate, wherein a first surface of the rotating element that away from the housing comprises a second stopping portion disposed thereon, and when the rotating element is at a locked position, the second stopping portion is on a moving path of the first stopping portion to restrain the first stopping portion.

8. The ejecting mechanism according to claim 7, wherein the second stopping portion is a protrusion.
